(19) United States
(12) Patent Application Publication
(10) Pub. No.: US 2024/0390115 A1
(43) Pub. Date: Nov. 28, 2024

(54) ORTHODONTIC BRACKET

(71) Applicant: MEDICEN CO., LTD, Seoul (KR)

(72) Inventor: Soon Yong KWON, Seoul (KR)

(73) Assignee: MEDICEN CO., LTD, Seoul (KR)

(21) Appl. No.: 18/699,306

(22) PCT Filed: Nov. 15, 2021
(86) PCT No.: PCT/KR2021/016620

§ 371 Date: Apr. 8, 2024

(30) Foreign Application Priority Data
Oct. 8, 2021 (KR) 10-2021-0134130
Oct. 13, 2021 (KR) 10-2021-0135981

(51) Int. Cl. A61C 7/28; A61C 7/12

(52) U.S. Cl. CPC A61C 7/287; A61C 7/125

(57) ABSTRACT

An orthodontic bracket is disclosed. The orthodontic bracket according to the present invention includes: a bracket body having a slot formed through the bracket in a direction of right and left; and a bracket cover movably provided on the bracket body to open and close a top of the slot. The bracket cover includes: a cover body provided at a side of the slot for moving forward and backward across the slot; and crossing protrusions formed at a front end of the cover body which faces an opposite side of the slot. and protruding forward with gaps in the direction of right and left. According to the present invention, since when the bracket cover is closed for ligating a wire, the front end of the bracket cover can smoothly slide over the wire, so the bracket cover can be easily closed.

### TECHNICAL FIELD

The present invention relates to a bracket for orthodontics and, more particularly, to an orthodontic bracket that is a self-ligating bracket that can open/close a slot in which a wire is inserted.

### BACKGROUND ART

Orthodontics is a surgical operation for correcting a crooked teeth, bimaxillary protrusion, and malocclusion with fixed or removable braces. Orthodontics has both a medical function that correct an uneven set of teeth that causes inconvenience in daily life and an aesthetic function that makes a beautiful face by correcting the crooked teeth.

Metal is generally used as the material of orthodontic appliances, but, recently, ceramic is also used. For example, ceramic brackets are used for anterior teeth and metal brackets are used for posterior teeth such as molar teeth, but using the ceramic brackets increases the cost, as compared with using the metal brackets.

The bracket is an orthodontic appliance for orthodontics, as described above. The brackets are attached to a surface of the teeth, and a wire such as an archwire is inserted into a slot of bracket, so that torque of the wire is continuously applied to the teeth and orthodontics is performed.

As described above, the bracket and the wire are used for orthodontics. The brackets are fixed on tooth surfaces and support the wires, so that the orthodontic force generated by the wire is transmitted to the teeth through the brackets.

Such brackets, that is, orthodontic brackets are attached to tooth surfaces usually by dental resin. Common brackets have a slot formed on the front surface of the brackets for insertion of the wire, a bracket base is attached to a tooth surface, and the angle of the slot is very important for accuracy of the orthodontic treatment.

Conventional brackets have wings for ligating the wire inserted in the slot. Accordingly, a ligating member, for example, an elastic band is wound on the wings after the wire is inserted into the slot, thereby preventing separation of the wire.

The conventional bracket includes a bracket base that can be attached to a tooth surface and a bracket body provided on the bracket base. The slot is formed at the bracket body and the ligating member is wound around the bracket body, thereby preventing separation of the bracket and the wire.

According to a self-ligating bracket that is a kind of brackets, a bracket cover mounted on a bracket body having the slot opens/closes the slot, thereby preventing separation of a wire.

### DISCLOSURE

### Technical Problem

An objective of the present invention is to provide an orthodontic bracket that can prevent a bracket cover for opening/closing a slot from not being closed by being stuck to a wire passing through the slot.

### Technical Solution

An aspect of the present invention provides an orthodontic bracket that includes: a bracket body having a slot formed through the bracket in a direction right and left; and a bracket cover movably provided on the bracket body to open and close a top of the slot. The bracket cover includes: a cover body provided at a first side of the slot and being able to move forward and backward across the slot; and crossing protrusions formed at a front end of the cover body which faces a second side of the slot. The crossing protrusions protrude forward and spaced apart in the direction of right and left. The crossing protrusions may form bilateral symmetry.

A pair of the crossing protrusions may be provided at the front end of the cover body, one of the crossing protrusions may be formed at the left portion of the front end of the cover body with a predetermined gap to the left from the center of the front end of the cover body, and the other one may be formed at the right portion of the front end of the cover body with a predetermined gap to the right from the center of the front end of the cover body.

For example, the crossing protrusions may include a left protrusion formed at the left portion of the front end of the cover body and a right protrusion formed at the right portion of the front end of the cover body. The left protrusion may be formed to have a predetermined width from the left edge of the cover body and the right protrusion may be formed to have a predetermined width from the right edge of the cover body.

The top of the slot is opened/closed by the bracket cover; and the bottoms of the crossing protrusion may be connected to the bracket cover without a step. The bottoms of the crossing protrusions may have a slope that is higher at the front.

The slope may be formed at the front end of the bottom of the crossing protrusions, but is not limited thereto. The slope may have a round shape, but is not limited thereto, and for example, may have an inclined shape having a predetermined angle.

The thickness of the crossing protrusion may be changed in the direction of right and left or may be uniform. For example, the tops of the crossing protrusions may be inclined in the width direction, or gradients of the tops may be uniform. As a more detailed example, tops of the crossing protrusions may have a slope that becomes lower toward the center of the front end of the bracket cover, and outer portions of the crossing protrusions may be thicker than inner portions of the crossing protrusions.

The bracket body may include: a cover support having guide rails that guides sliding of the bracket cover, and provided at the first side of the slot to support the bracket cover; and a counter-body having engaging recesses, in which the crossing protrusions are fitted when the bracket cover is closed, and disposed opposite to the cover body to face the crossing protrusions.

Front end tops of the crossing protrusions may have an upward convex shape to be locked to the engaging recesses; and locking bumps formed at the upper portions of the engaging recesses for accommodating the front end tops and preventing separation of the crossing protrusions by locking the front end of the crossing protrusions.

There may be a clearance, that is, an up-down clearance in which the crossing protrusions of the bracket cover can be moved up and down within a predetermined range while the bracket cover is moved from the open position to the closed position.

The orthodontic bracket may further include an elastic member provided at a front half of the bracket cover to move with the bracket cover, protruding under the bracket cover, and supported by the bracket body.

Another aspect of the present invention provides an orthodontic bracket that includes: a bracket body having as slot formed through the bracket in a width direction; and a bracket cover movably provided on the bracket body to open and close a top of the slot, in which the bracket cover includes: a cover body provided at a first side of the slot and being able to move forward and backward in a crossing direction of the slot; and crossing protrusions formed at a front end of the cover body which faces a second side of the slot and protruding forward with gaps in the width direction.

Another aspect of the present invention provides an orthodontic bracket that includes: a bracket body having as slot formed through the bracket in a width direction; and a bracket cover movably provided on the bracket body to open and close a top of the slot, in which the front end of the bracket cover have a middle portion higher than a left portion and aright portion of the front end of the bracket cover.

### Advantageous Effects

According to the present invention, since when the bracket cover is closed to ligate a wire, the front end of the bracket cover can smoothly slide over the wire, so the bracket cover can be easily and smoothly closed. And, when the bracket cover is at a closed position, the front end of the bracket cover is locked and restricted by the bracket body, so that it is possible to suppress unintended opening of the bracket cover. Furthermore, since the middle portion of the bottom of the slot is recessed, friction that is applied to a wire can be reduced.

### DESCRIPTION OF DRAWINGS

The features and advantages of the present invention can be well appreciated with the following detailed description of embodiments and drawings, in which:

FIG. 1 is a perspective view showing an open state of an orthodontic bracket according to an embodiment of the present invention;

FIG. 2 is a perspective view showing a closed state of the bracket shown in FIG. 1;

FIG. 3a is a plan view showing the state in which a wire is inserted in the bracket shown in FIG. 1;

FIG. 3b is a rear view of the bracket shown in FIG. 1;

FIG. 4 is a side view showing an open state of the bracket shown in FIG. 1;

FIGS. 5a and 5b are side views showing a wire inserted in a slot of the bracket shown in FIG. 1 and a ligature state of the wire, respectively;

FIG. 6 is a cross-sectional view along line A-A of FIG. 3;

FIG. 7 is a cross-sectional view showing an open state of the bracket along line A-A of FIG. 3;

FIGS. 8a and 8b are a perspective view and a plan view showing a bracket body of the bracket shown in FIG. 1;

FIG. 9 is a cross-sectional view along line B-B of FIG. 8b;

FIG. 10 is a cross-sectional view along line C-C of FIG. 8b;

FIG. 11 is a perspective view showing a bracket cover of the bracket shown in FIG. 1;

FIG. 12 is a plan view and a front view of the bracket cover shown in FIG. 11;

FIG. 13 is a cross-sectional view taken along line D-D of FIG. 12;

FIG. 14 is a cross-sectional view taken along line E-E of FIG. 12;

FIG. 15 is a perspective view showing an embodiment of an elastic member for the bracket shown in FIG. 1;

FIG. 16 is a perspective view and a plan view of a bracket cover of an orthodontic bracket according to another embodiment of the present invention;

FIG. 17 is a plan view of the bracket cover shown in FIG. 16;

FIG. 18 is a perspective view of a bracket body of the orthodontic bracket according to another embodiment of the present invention; and

FIG. 19 is a perspective view and a plan view of a bracket cover of an orthodontic bracket according to another embodiment of the present invention.

### BEST MODE

Hereafter, preferred embodiments that can achieve the objectives of the present invention is described with reference to the accompanying drawings. In the description of the embodiments, the same components are given the same names and reference numerals.

The terms used herein are used to explain the embodiments of the present invention only and are not intended to limit the present invention. The terms regarding numbers such as “first” and “second” may be used to discriminate components having the same names, but are not intended to define or limit the numbers of the components.

It is to be understood that when one element is referred to as being “connected to” or “coupled to” other element, it may be connected directly to or coupled directly to other element, or be indirectly connected to or coupled to other element with another element therebetween.

In this specification, it should be understood that term “include” or “have” indicates that a feature, a number, a step, an operation, a component, a part or the combination thereof described in this specification is present, but does not exclude a possibility of presence or addition of one or more other features, numbers, steps, operations, components, parts or combinations thereof.

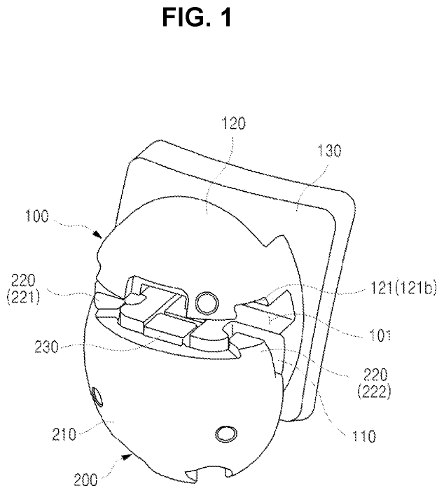

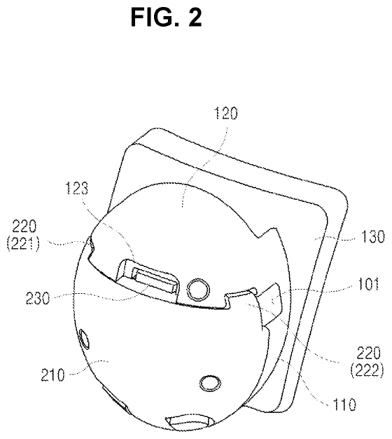

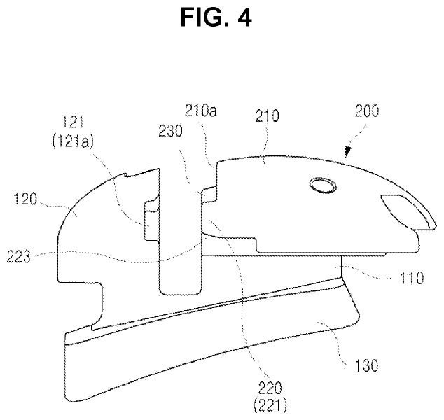

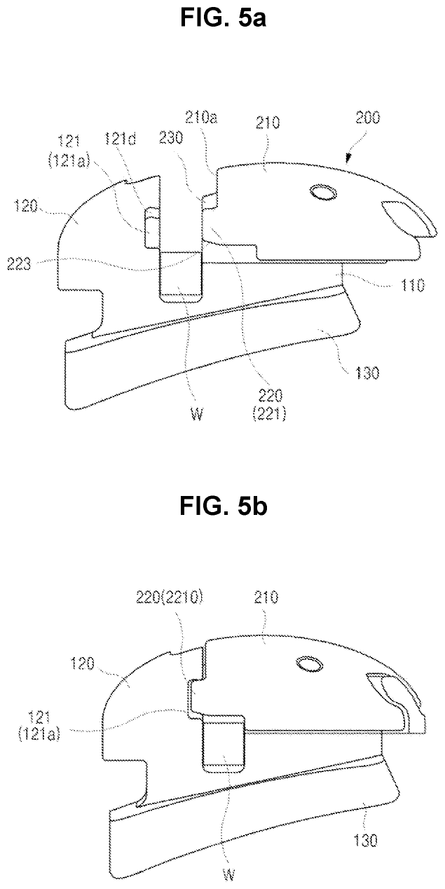

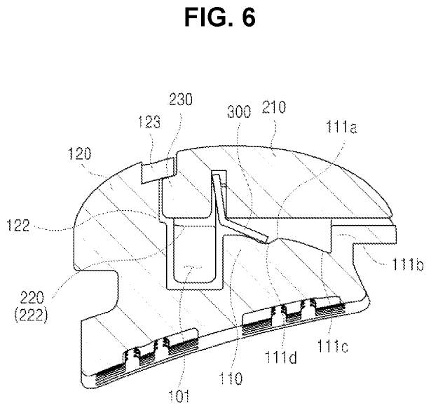

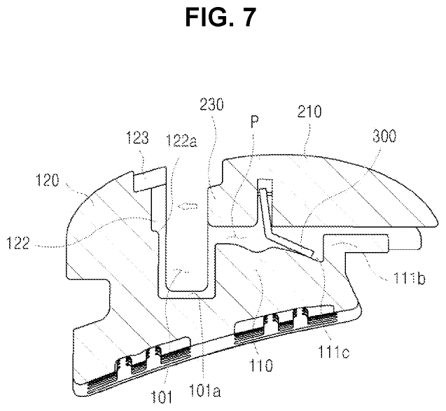

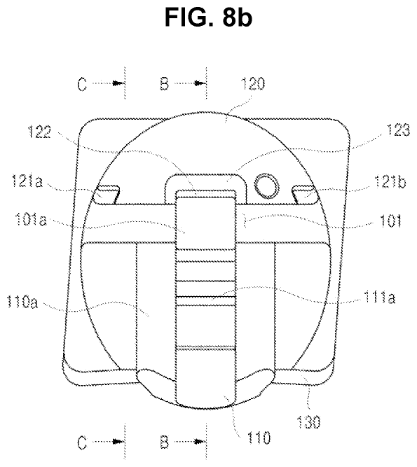

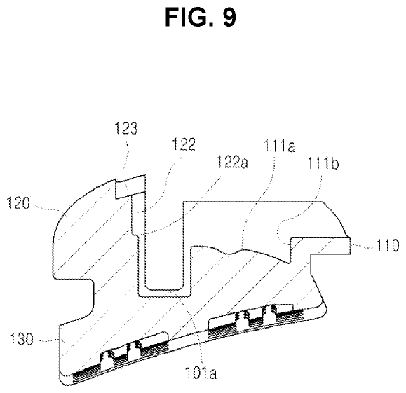

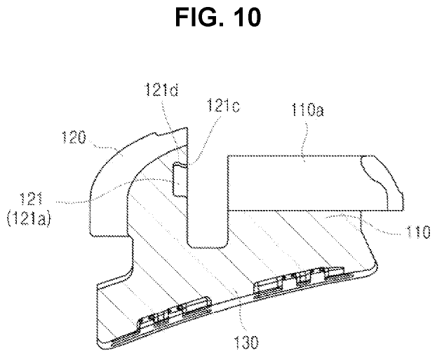

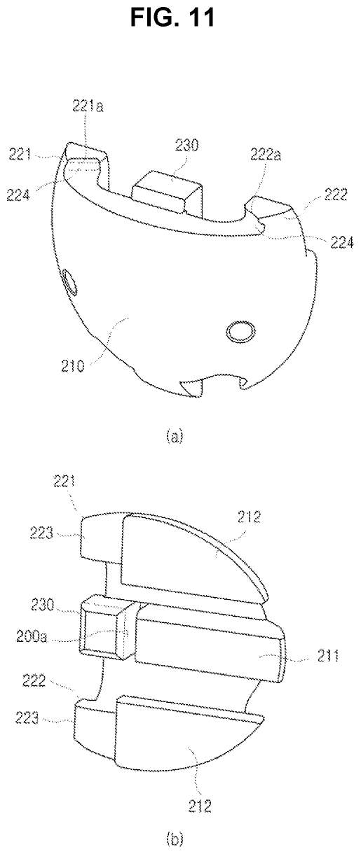

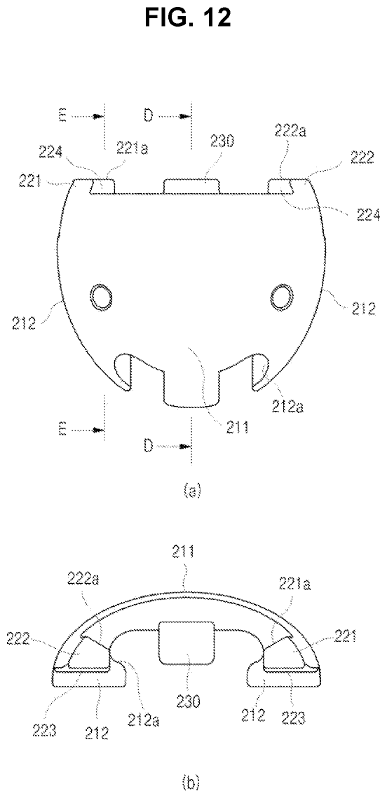

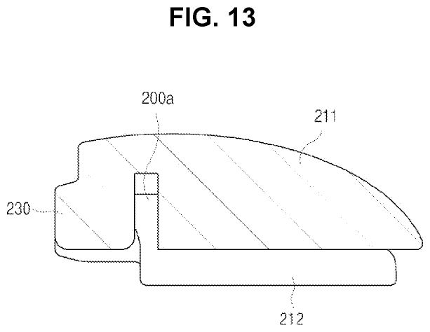

Referring to FIGS. 1 to 15, an orthodontic bracket (hereinafter, referred to as a ‘bracket’) according to an embodiment of the present invention includes a bracket body 100 having a slot 101 for inserting a wire W, and a bracket cover 200 provided at the bracket body 100. An embodiment of the present invention may be implemented in a self-ligating bracket type.

When the bracket 100 is placed on a floor such that the top of the slot 101 is open, the slot 101 is formed through the bracket body 100 in the right and left direction so that the wire W passes in the width direction. The bracket cover 200 is movably provided on the bracket body 100 to open/close the slot 101 and the top of the slot 101 is opened/closed by the bracket cover 200.

In this embodiment, the bracket body 100 includes a cover support 110 provided at a first side of the slot and supporting the bracket cover, and a counter-body 120 provided at a second side opposite to the cover support, that is, at front side of the cover support.

The bracket cover 200 is movably provided at the first side of the slot 101 to be able to cross the slot 101, that is, to move forward and backward. Referring to FIGS. 1, and 11 to 14, the bracket cover 200 includes a cover body 210 being able to move forward and backward, and crossing protrusions 220 formed at the front end 210a of the cover body.

The crossing protrusions 220 are formed at the front end of the cover body 210 toward the second side of the slot 101 and protrude forward with gaps in the right and left direction.

The crossing protrusions 220 of this embodiment form bilateral symmetry. For example, a pair of crossing protrusions 220 are provided at the front end of the cover body 210. One 221 of the crossing protrusions 220 may be formed at the left portion of the cover body 210 with a predetermined gap to the left from the center of the front end of the cover body and the other one 222 may be formed at the right portion of the cover body 210 with a predetermined gap to the right from the center of the front end of the cover body 210.

Accordingly, the crossing protrusions 210 include a left protrusion 221 formed at the left portion of the front end of the cover body and a right protrusion 222 formed at the right portion of the front end of the cover body. The left protrusion 221 may have a predetermined width at the left front edge of the cover body and the right protrusion 222 may have a predetermined width at the right front edge of the cover body.

As described above, the top of the slot 101 is opened/closed by the bracket cover, and in this embodiment, the bottoms of the crossing protrusions 221 and 222 each have a slope 223 that becomes higher toward the front.

For example, the slope 223 may be formed at the front ends of the bottoms of the crossing protrusions 221 and 222, but is not limited thereto. And the entire bottoms of the crossing protrusions 221 and 222 may be inclined to become higher toward the front. The slope 223 may have a round shape, that is, a curved shape, but is not limited thereto, and for example, may have an inclined surface at a predetermined angle. It is preferable that the bottoms of the crossing protrusions 221 and 222 are connected to the front end of the cover body 210 without a step.

Accordingly, when the bracket cover 200 is closed to ligate a wire, the crossing protrusions 221 and 222 can easily slide over the wire W due to the slopes 223 of the crossing protrusions 221 and 222. Since the crossing protrusions 221 and 222 are spaced apart from each other, the crossing protrusions 221 and 222 can easily slide over the wire W at the left and right regions of the slot even if the wire W partially protrudes upward at the center portion of the slot 101.

The thickness of the crossing protrusions 221 and 222 may be uniform in the width direction, or may change like this embodiment along the width direction. For example, the tops of the crossing protrusions 221 and 222 may be inclined in the width direction, or uniform. As a more detailed example, the top surface of the crossing protrusions 221 and 222 may have a taper 224 that becomes lower toward the center of the front end of the bracket cover, and in this embodiment, the outer portions of the crossing protrusions 221 and 222 may be thicker than the inner portions of the crossing protrusions 221 and 222.

In other words, the left protrusion 221 may be thicker at the left portion than the right portion, and the right protrusion 222 may be thicker at the right portion than the left portion, whereby the crossing protrusions 221 and 222 can be reinforced.

As in this embodiment, a center protrusion 230 may be formed forward in the region between the crossing protrusions 221 and 222. The center protrusion 230 is formed at the center of the front end of the cover body 210.

In this embodiment, the height of the bottoms of the crossing protrusions 221 and 222 is constant along the width direction, and the bottom of the center protrusion 230 is higher than the bottoms of the crossing protrusions 221 and 222.

As described above, the bracket cover 200 is slidably provided on the bracket body 100, thereby opening/closing the slot 101. The bracket body 100, more particularly, the cover support 110 supports the bracket cover 200 and guides sliding of the bracket cover 200.

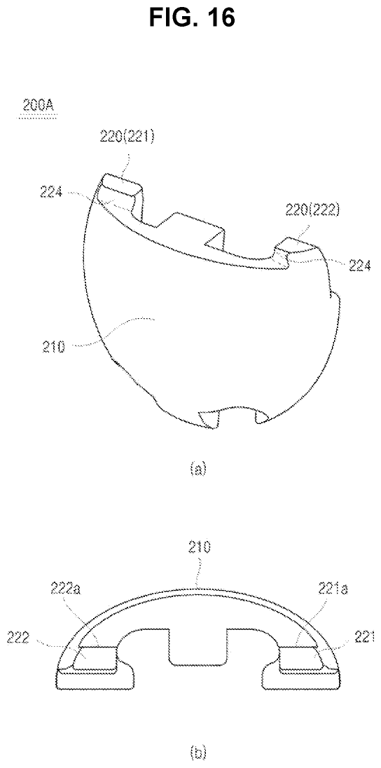

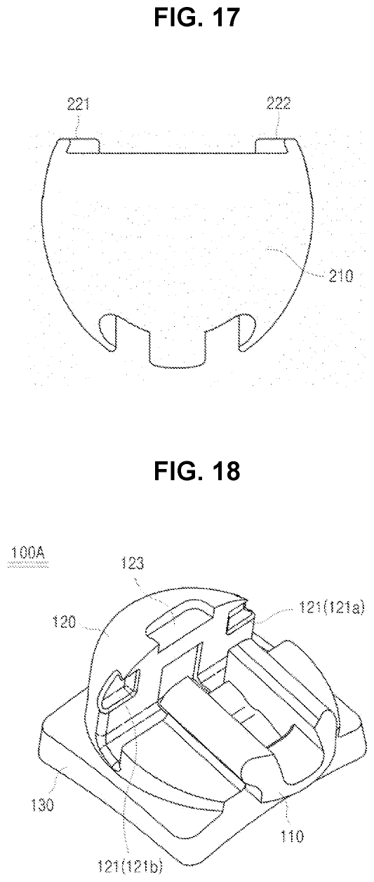

Referring to FIGS. 1 to 19, the bracket body 100, as described above, includes the cover support 110 and the counter-body 120. The cover support 110 has guide rails 110a that guide sliding of the bracket cover 200 and is provided at the first side of the slot 101, that is, the side of the slot to support the bracket cover 200.

The cover support 110 may be a signal body or an assembly of a plurality of members, and the counter-body 120 may also be a single body or an assembly of a plurality of members.

The counter-body 120 is provided at the second side of the slot 101, that is, front side of the slot 101 to face the crossing protrusions 221 and 222. Accordingly, the counter-body 120 is formed at front side of the cover support 110.

In this embodiment, the bracket body 100, particularly, the cover support 110 can prevent the bracket cover 200 from taking off upwardly. In other words, the bracket body 100 prevents the bracket cover 200 from separating from the bracket body 100 in the up-down direction when the bracket cover 200 slides.

The guide rails 100a guide movement of the bracket cover 200 and prevent the bracket cover 200 from coming off the bracket body 100. In this embodiment, the guide rails 100a are formed on both sides of the cover support 110.

Assuming that the sliding direction of the bracket cover 200 is an X-axial direction, since the bracket cover 200 slides while being engaged with the guide rails 100a on both sides of the cover support, separation of the bracket cover can be prevented in a Y-axial direction (up-down direction) and/or in a Z-axial direction (e.g., the right and left direction or width direction) perpendicular to the X-axial direction.

A base 130 that can be attached to a tooth surface (a lingual side, a labial side, or a buccal side) is provided under the cover support 110. Accordingly, the bottom of the base 130 is a tooth attachment surface, and roughness 131 may be formed on the bottom of the base 130.

In this embodiment, the cover support 110 and the counter-body 120 are formed as one body with the base 130, but the base 130 may be coupled to the bottom of an upper body including the cover support 110 and the counter-body 120.

The cover support 110 forms a first wall (rear wall) of the slot 101 and the counter-body 120 forms a second wall (front wall) of the slot 101. The base 130 is provided under the slot 101, and the cover support 110 and the counter-body 120 120 are formed on the base 130.

The bracket cover 200 is mounted on the cover support 110 and the counter-body 120 is opposite to the cover support 110. Accordingly, the cover support 110 and the counter-body 120 are separated by the slot 101.

In this embodiment, the counter-body 120 has engaging recesses 121 in which the crossing protrusions 221 and 222 are fitted when the bracket cover 200 is closed. The engaging recesses 121 are formed on the rear surface of the counter-body 120 to be concave forward, and include a left recess 121a facing the left protrusion 221 and a right recess 121b facing the right protrusion 222.

When the bracket cover 200 is closed, the left protrusion 221 and the right protrusion 222 are fitted in the left recess 121a and the right recess 121b and the front portion of the cover body 210 covers the top of the slot 101. The engaging recesses 121 may not be formed, and in this case, the crossing protrusions 220 partially or entirely cover the top of the slot 101.

A center recess 122 facing the center protrusion 230 of the bracket cover and having a space for accommodating the center protrusion may be formed between the left recess 121a and the right recess 121b.

In this embodiment, the center recess 122 forms a step 122a on the rear surface of the counter-body, so when the bracket cover is closed, the center protrusion 30 is moved onto the step 122a. The top of the center recess 122 is open and a cover-opening recess 123 for opening the bracket cover 200 is formed at the counter-body 120.

In this embodiment, the cover-opening recess 123 is wider than the center recess 122 on the top of the counter-body 120 and is open on the rear end, and in more detail, is formed over the center recess 122 and communicates with the center recess 122. When the bracket cover 200 is closed, the rear of the cover-opening recess 123 is closed by the front end of the cover body 210. A bottom recess 101a is formed at the middle portion of the bottom of the slot, so friction with a wire can be reduced.

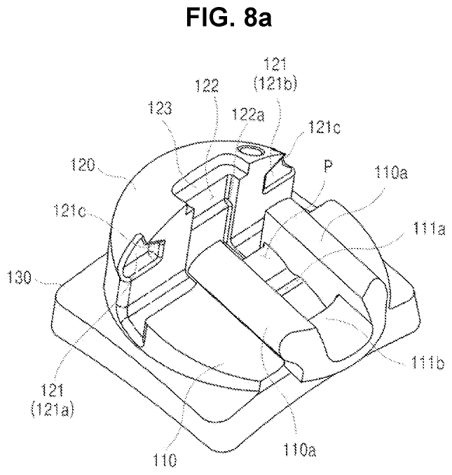

Referring to FIGS. 8a, and 8b to 14, the front end tops 221a and 222a of the crossing protrusions have an upward convex shape to be locked to the engaging recesses 121. Locking bumps 121c forming spaces for accommodating the front end tops 221a and 222a of the crossing protrusions and preventing separation of the crossing protrusions 221 and 222 by locking the front end tops 221a and 222a of the crossing protrusions are formed at the upper portions of the engaging recesses 121.

The tops 121d of the engaging recesses 121 are inclined in a shape corresponding to the slopes of the tops of the crossing protrusions 221 and 222. That is, the engaging recesses 121 have a shape of which the height decreases toward the center of the counter-body 120.

The bracket according to this embodiment has a clearance, that is, an up-down gap for up-down movement of the bracket cover so that the crossing protrusions of the bracket cover can be moved up and down within a predetermined range while the bracket cover is moved from the open position to the closed position.

The bracket cover 200 has an elastic member 300. The elastic member 300 protrudes under the bracket cover 200, so the elastic member 300 is supported by the bracket body 100 and moved with the bracket cover 200.

In this embodiment, the elastic member 300 is a component that maintains the position of the bracket cover 200 and can elastically deform to open/close the bracket cover 200.

More particularly, the elastic member 300 is provided inside the bracket cover 200 and has elasticity. In this embodiment, the elastic member 300 is a component that is coupled to the bracket cover 200 moves with the bracket cover 200 and maintains the position of the bracket cover 200. The elastic member 300 may be implemented in various types such as an elastic member, for example, having a plate shape.

The bracket body 100 has a stopper 111 for restricting movement of the bracket cover and the stopper 111 maintains the position of the bracket cover 200 by blocking the elastic member 300.

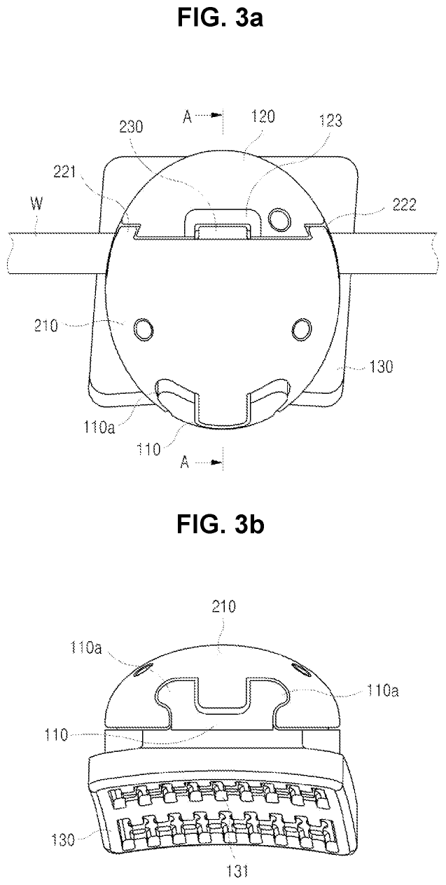

Referring to FIGS. 3 to 9, the stopper 111 of this embodiment is formed at the cover support 110. More particularly, the stopper 111 has a stopping portion 111a formed on the top of the cover support 110.

The stopping portion 111a restricts backward movement of the bracket cover when the bracket cover 200 is at the closed position, and restricts forward movement of the bracket cover when the bracket cover 200 is at the open position. That is, the position of the bracket cover 200 is maintained by interaction of the stopping portion 111a and the elastic member 300.

In this embodiment, the stopper 111 may further have an anti-separation portion 111b that prevents the bracket cover 200 from separating from the bracket body 100 by restricting backward movement of the bracket cover 200 when the bracket cover 200 is at the open position.

The stopping portion 111a is a protruding bump formed ahead of the anti-separation portion 111b, and a first recession 111c lower than the stopping portion 111a and the anti-separation portion 111b is formed between the stopping portion 111a and the anti-separation portion 111b. The stopping portion 111a is formed between the slot 101 and the anti-separation portion 111b, and a second recession 111d lower than the stopping portion 111a is formed ahead of the stopping portion 111a.

The stopping portion 111a and the anti-separation portion 111b are formed on the top of the cover support 110 to be positioned in the movement path P of the elastic member 300. Accordingly, the stopping portion 111a prevents the bracket cover 200 from being opened (moved backward) at the closed position and prevents the bracket cover 200 from moving forward beyond the bracket body 100 at the open position. The anti-separation portion 111b prevents the bracket cover 200 from separating backward from the bracket body 100 at the open position.

The bracket cover 200 and the elastic member 300 are integrally moved, and in this embodiment, the stopping portion 111a and the anti-separation portion 111b restrict movement of the bracket cover 200 by blocking the elastic member 300.

Accordingly, the stopper 111 of the bracket body can apply a force that maintains the position of the bracket cover 200 through the elastic member 300.

In other words, the bracket cover 200 is indirectly restricted by the stopper 111 through the elastic member 300. The elastic member 300 is provided under the bracket cover 200 to be able to elastically deform to open/close the bracket cover 200, and can pass, that is, slide over the stopping portion 111a by elastic deformation. A mechanism for maintaining the position of the bracket cover is not limited to the above example.

The elastic member 300 is moved forward and backward along the middle region of the cover support 110, and the movement path P of the elastic member is formed in the front-rear direction in the middle region of the cover support 110. The elastic member 300 may have a spring structure, for example, a plate spring structure that is pressed upward to elastically deform by the stopping portion 111a when the bracket cover 200 is opened/closed.

In more detail, according to this embodiment, the elastic member 200, which is a type of cantilever fixed to the bracket cover, is elastically deformed by being pressed by the stopping portion 111a when the bracket cover is opened/closed.

The elastic member 300 is elastically deformed by being pressed upward by the stopping portion 111a to be able to slide over the stopping portion 111a when the bracket cover 200 is opened/closed, so a lifting force is applied to the bracket cover when the bracket cover 200 starts to be closed.

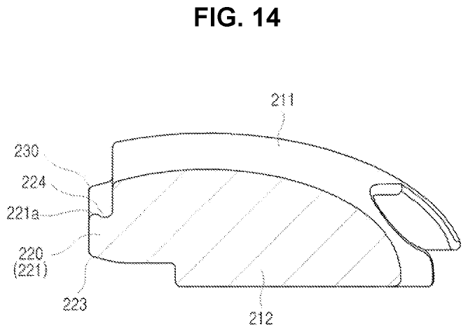

Referring to FIG. 15, the elastic member 300 is fixed to the bracket cover 200 in is a cantilever structure having a bending shape. With respect to the bend 301 of the elastic member 300, the upper part of the elastic member 300 is fixed to the bracket cover 200 and the lower part of the elastic member 300 is locked to the stopper 111 as a free end and can slide over the stopping portion 111a while elastically deforming when a predetermined force is applied to the bracket cover.

In this embodiment, the lower part of the elastic member 300 is bent backward with respect to the bend 301 and extends downward at an angle of slope.

The bracket cover 200 has a fitting groove 200a for insertion of the elastic member 300. In this embodiment, the fitting groove 200a is formed on the bottom of the bracket cover 200, and the upper part of the elastic member 300 may be inserted and fixed by resin in the fitting groove 200a or the upper part of the elastic member 300 may be fixed in the fitting groove 200a by interference fit. However, the present invention is not limited thereto, and for example, the elastic member 300 may be fixed to the bracket 200 by a fastener such as a screw.

The cover body 210 includes a slid cap 211 covering the cover support 110 and cover wings 212 formed at both sides of the cap 211 and coupled to both sides of the cover support 110, respectively.

In this embodiment, the guide rails 110a are formed on both sides of the cover support 110 and the cover wings 212 cover both edges of the bracket body, and a counter rails fitted on the guide rail 110 is formed on each of the cover wing 212.

A groove may be applied for any one of the guide rails 110a and the counter rails 212a, and a protrusion may be applied for the other one. In this embodiment, the guide rails 110a are protrusions and the counter rails are grooves in which the guide rails 110a are fitted, and the guide rails 110a are elongated along both sides of the cover support 110. In this embodiment, the crossing protrusions 220 protrude forward from the front ends of the cover wings 212.

Accordingly, when the lower part of the elastic member 300 is positioned in the first recession 111c, the open state of the bracket cover 200 is maintained. When the lower part of the elastic member 300 is positioned in the second recession 111d beyond the stopping portion 111a, the closed state of the bracket cover 200 can be maintained.

When a predetermined force is applied to the bracket cover 200 in the sliding direction of the bracket cover 200 to open/close the bracket cover 200, the elastic member 300 elastically deforms while sliding over the stopping portion 111a. After sliding over the stopping portion 111a, the elastic member 300 returns to the initial shape and is locked to a side or another side of the stopping portion 111a.

In this embodiment, the elastic member 300 is positioned at the front half of the bracket cover 200, in more detail, at the front half of the cover body 210, so when the bracket cover 200 moves to be closed, the front end of the bracket cover is lifted. Since the front end of the bracket cover 200 is lifted, it can more easily slide over a wire W.

In this embodiment, the top surface of the bracket cover 200 has a round shape that is convex. In more detail, when the bracket cover 200 is closed, the edge of the orthodontic bracket entirely makes a round surface and the top surface of the orthodontic bracket has the round shape that lowers toward the edges. For example, when the bracket cover 200 is closed, the top surface of the orthodontic bracket has the round surface of a streamlined form of round structure such as a sphere or an ellipsoid, whereby it is possible to minimize inconvenience such as interference with the tongue when the bracket is attached to a tooth. Of course, the outer shape of the bracket is not limited to a rounded curved shape.

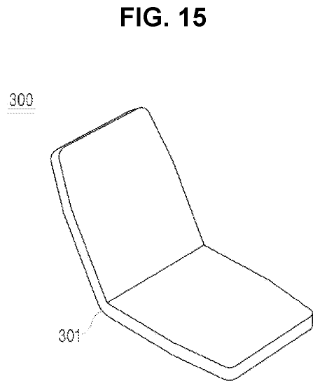

Referring to FIGS. 16 to 18, another embodiment of the orthodontic bracket according to the present invention includes a bracket body 100A having the slot described above, and a bracket cover 200A for ligation of a wire.

The bracket cover 200A includes a cover body 210 movably provided on the bracket body 100A, and crossing protrusions 220 formed at the front end of the cover body and protruding forward with gaps in the right and left direction.

The crossing protrusions 220 of this embodiment may include a left protrusion 221 formed at the left portion of the front end of the cover body and a right protrusion 222 formed at the right portion of the front end of the cover body. As in this embodiment, the portion between the left protrusion 221 and the right protrusion 222 is empty. And the thickness of the crossing protrusions may be uniform in the width direction.

The bracket body 100A, as in the first embodiment described above, includes a cover support 110 and a counter-body 120, and the counter body 120 may have engaging recesses 121 having a shape corresponding to the crossing protrusions so that the crossing protrusions are fitted therein. The engaging recesses 121 are formed on the rear surface of the counter-body 120 to be concave forward, and include a left recess 121a facing the left protrusion 221 and a right groove 121b facing the right protrusion 222.

The rear surface of the counter-protrusion 120 has a structure corresponding to the shape of the front end of the bracket cover. When the portion between the left protrusion 221 and the right protrusion 222 is empty, in other words, the center protrusion of the first embodiment described above is omitted, the center recess of the first embodiment described above may be omitted on the rear surface of the counter-body 120.

The configuration described in the first embodiment may be applied in the same way to other configuration except for the front end structure of the bracket cover and the rear surface structure of the counter-body, and the elastic member 300 described above may also be applied to this embodiment. Accordingly, other components except for the front end structure of the bracket cover and the structure of the counter-body corresponding to the front end structure of the bracket cover are not repeatedly described.

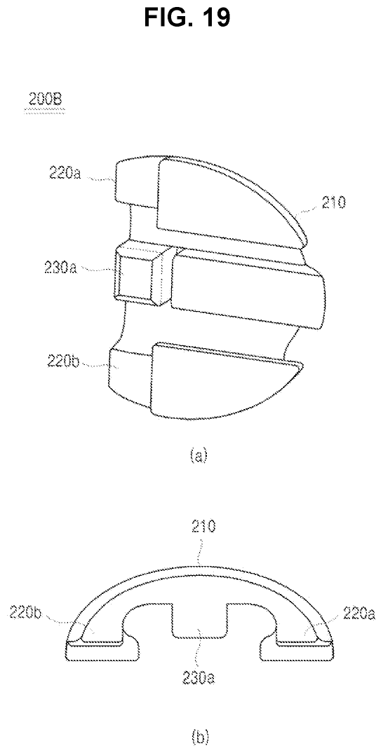

Next, another embodiment (a third embodiment) of an orthodontic bracket according to the present invention is described. This embodiment, as shown in FIG. 19, may include a bracket cover 200b having a front end at which a left portions 220a and a right 220b are lower than a middle portion 230a, and a bracket body on which the bracket cover is movably mounted. Though not shown, it can be seen that the bracket body for this embodiment may include a counter-body having a structure in which the rear surface of the counter-body 120 described above in the first or second embodiment is changed to have a shape corresponding to the shape of the front end of the bracket cover for the third embodiment.

The configuration described in the first embodiment may be applied in the same way to other configuration except for the front end structure of the bracket cover and the rear surface structure of the counter-body, and the elastic member 300 described above may also be applied to this embodiment. Accordingly, other components except for the front end structure of the bracket cover and the structure of the counter-body corresponding to the front end structure of the bracket cover are not repeatedly described.

Although preferred embodiments of the present invention were described above, it would be apparent to those skilled in the art that the present invention may be achieved in other specific types without departing from the scope or spirit other than the embodiments described above.

Accordingly, the embodiments described above should be considered as being exemplifying rather than limiting, so the present invention may be changed within the range of the claims and the equivalent range without being limited to the above description.

### INDUSTRIAL APPLICABILITY

The present invention relates to an orthodontic appliance, more particularly, provides an orthodontic bracket that can be used in the field of orthodontic appliances in relation to brackets for supporting a wire, can stably transmit force of the wire to teeth, can easily ligate the wire, and can easily open/close.

1. An orthodontic bracket comprising:
a bracket body having a slot formed through the bracket in a direction of right and left; and
a bracket cover movably provided on the bracket body to open and close a top of the slot,
wherein the bracket cover includes:
a cover body provided at a first side of the slot for moving forward and backward across the slot; and
crossing protrusions formed at a front end of the cover body which faces a second side of the slot, the crossing protrusions protruding forward and being spaced apart in a direction of right and left.

2. The orthodontic bracket according to claim 1, wherein the crossing protrusions are symmetrical.

3. The orthodontic bracket according to claim 1, wherein a pair of the crossing protrusions are provided at the front end of the cover body, one of the crossing protrusions is formed at the left portion of the front end of the cover body with a predetermined gap from the center of the front end of the cover body, and the other one is formed at the right portion of the front end of the cover body with a predetermined gap from the center of the front end of the cover body.

4. The orthodontic bracket according to claim 1, wherein the bottoms of the crossing protrusion are connected to the bracket cover without a step.

5. The orthodontic bracket according to claim 1, wherein the bottoms of the crossing protrusions have a slope that is higher at the front.

6. The orthodontic bracket according to claim 5, wherein the slope is formed at the front portion of the bottom of the crossing protrusions.

7. The orthodontic bracket according to claim 5, wherein the slope has a round shape.

8. The orthodontic bracket according to claim 1, wherein tops of the crossing protrusions have a slope that becomes lower toward the center of the front end of the bracket cover, and outer portions of the crossing protrusions are thicker than inner portions of the crossing protrusions.

9. The orthodontic bracket according to claim 1, wherein the bracket body includes:
a cover support having guide rails that guides sliding of the bracket cover, and provided at the first side of the slot to support the bracket cover; and
a counter-body having engaging recesses, in which the crossing protrusions are fitted when the bracket cover is closed, and provided opposite to the cover body to face the crossing protrusions.

10. The orthodontic bracket according to claim 1, wherein tops of front end of the crossing protrusions have an upward convex shape to be locked to the engaging recesses; and the engaging recesses have locking bumps formed at the upper portions of the engaging recesses for accommodating the tops of front end and preventing separation of the crossing protrusions by locking the front end.

11. The orthodontic bracket of claim 1, wherein the crossing protrusions is configured to move up and down within a predetermined range while the bracket cover is moved from an open position to a closed position.

12. The orthodontic bracket of claim 11, further comprising an elastic member provided at a front half of the bracket cover to move with the bracket cover, protruding under the bracket cover, and supported by the bracket body.
